(19) United States
(12) Patent Application Publication
(10) Pub. No.: US 2026/0330317 A1
(43) Pub. Date: Oct. 22, 2026

(54) METHOD, APPARATUS, DEVICE, AND STORAGE MEDIUM FOR MODEL TRAINING OPTIMIZATION

(71) Applicants: Beijing Zitiao Network Technology Co., Ltd., Beijing (CN); Bytedance Technology Ltd., Grand Cayman (KY)

(72) Inventors: Jianzhong LIANG, Beijing (CN); Huafeng SHI, Beijing (CN); Cheng CHEN, Beijing (CN); Wen ZHOU, Beijing (CN); Kan WANG, Beijing (CN)

(21) Appl. No.: 19/654,300

(22) Filed: Apr. 21, 2026

(30) Foreign Application Priority Data
Apr. 21, 2025 (CN) 202510505307.5

(51) Int. Cl. G06N 20/00

(52) U.S. Cl. CPC G06N 20/00

(57) ABSTRACT

The disclosure provides a method, apparatus, device, and storage medium for model training optimization. The method includes: determining, for a plurality of operators of a generative machine learning model, resource usage information related to at least one memory optimization operation, where for each memory optimization operation, the resource usage information indicates a resource usage efficiency of performing the memory optimization operation on an operator of the plurality of operators in a training process of the generative machine learning model; determining, based on the resource usage information and available memory resources of a processing device for training the generative machine learning model, a memory optimization strategy for a group of operators of the plurality of operators; and training, by the processing device, the generative machine learning model by applying the memory optimization strategy.

### CROSS REFERENCE

The present application claims priority to Chinese Patent Application No. 202510505307.5, filed on Apr. 21, 2025, entitled “METHOD, APPARATUS, DEVICE AND STORAGE MEDIUM FOR MODEL TRAINING OPTIMIZATION”, which is incorporated herein by reference in its entirety.

### FIELD

Example embodiments of the present disclosure generally relate to the field of computer technologies, and more particularly, to a method, apparatus, device, and storage medium for model training optimization.

### BACKGROUND

A machine learning model is a type of algorithmic system that autonomously extracts inherent data patterns based on a data-driven algorithm and performs prediction or decision accordingly. With technological iterations, machine learning models are gradually capable of handling more complex and diverse tasks. For example, by using a machine learning model, a user may input text and/or a picture, and the machine learning model may generate content matching the text and/or picture input. Such a machine learning model may also be referred to as a generative machine learning model.

However, this technological progress also leads to more complex training data for machine learning models, which greatly increases the demand for memory resources in the model training process, thus causing the problem of insufficient memory resources.

### SUMMARY

In a first aspect of the present disclosure, a method for model training optimization is provided. The method includes: determining, for a plurality of operators of a generative machine learning model, resource usage information related to at least one memory optimization operation, where for a memory optimization operation of the at least one memory optimization operation, the resource usage information indicates a resource usage efficiency of performing the memory optimization operation on an operator of the plurality of operators in a training process of the generative machine learning model; determining, based on the resource usage information and available memory resources of a processing device for training the generative machine learning model, a memory optimization strategy for a group of target operators of the plurality of operators, the memory optimization strategy indicating performing one of the at least one memory optimization operation on a target operator of the group of target operators; and training, by the processing device, the generative machine learning model by applying the memory optimization strategy.

In a second aspect of the present disclosure, an apparatus for model training optimization is provided. The apparatus includes: a resource usage information determination module configured to determine, for a plurality of operators of a generative machine learning model, resource usage information related to at least one memory optimization operation, where for a memory optimization operation of the at least one memory optimization operation, the resource usage information indicates a resource usage efficiency of performing the memory optimization operation on an operator of the plurality of operators in a training process of the generative machine learning model; a memory optimization strategy determination module configured to determine, based on the resource usage information and available memory resources of a processing device for training the generative machine learning model, a memory optimization strategy for a group of target operators of the plurality of operators, the memory optimization strategy indicating performing one of the at least one memory optimization operation on a target operator of the group of target operators; and a model training module configured to train, by the processing device, the generative machine learning model by applying the memory optimization strategy.

In a third aspect of the present disclosure, an electronic device is provided. The device includes at least one processor; and at least one memory coupled to the at least one processor and storing instructions executable by the at least one processor, the instructions, when executed by the at least one processor, causing the device to perform the method of the first aspect.

In a fourth aspect of the present disclosure, a non-transitory computer-readable storage medium is provided. The computer-readable storage medium has computer-executable instructions stored thereon, which are executable by a processor to perform the method of the first aspect.

In a fifth aspect of the present disclosure, a computer program product is provided. The computer program product includes computer-executable instructions, which, when executed by a processor, implement the method of the first aspect.

It would be appreciated that the contents described in this section of the present disclosure are neither intended to limit the key features or important features of the embodiments of the present disclosure, nor are they intended to limit the scope of the present disclosure. Other features of the present disclosure will be readily envisaged through the following description.

### BRIEF DESCRIPTION OF THE DRAWINGS

The above and other features, advantages, and aspects of the embodiments of the present disclosure will become more apparent in combination with the drawings and with reference to the following detailed description. In the drawings, the same or similar reference numerals represent the same or similar elements, where:

FIG. 1 illustrates a schematic diagram of an example environment according to some embodiments of the present disclosure;

FIG. 2 illustrates a flowchart of an example process of a method for model training optimization according to some embodiments of the present disclosure;

FIG. 3 illustrates a flowchart of an example process of updating a memory optimization strategy according to some embodiments of the present disclosure;

FIG. 4A and FIG. 4B illustrate schematic diagrams of examples of performing memory optimization operations on operators in a traditional solution;

FIG. 4C illustrates a schematic diagram of an example of performing a memory optimization operation on an operator according to some embodiments of the present disclosure;

FIG. 5 illustrates a schematic structural block diagram of an apparatus for model training optimization according to some embodiments of the present disclosure; and

FIG. 6 illustrates a block diagram of an electronic device in which one or more embodiments of the present disclosure may be implemented.

### DETAILED DESCRIPTION OF EMBODIMENTS

The embodiments of the present disclosure will be described in more detail below with reference to the drawings. Although some embodiments of the present disclosure are shown in the drawings, it would be appreciated that the present disclosure may be implemented in various forms and should not be construed as limited to the embodiments set forth herein. Instead, these embodiments are provided for a more thorough and complete understanding of the present disclosure. It would be appreciated that the drawings and embodiments of the present disclosure are only for illustrative purposes, and are not intended to limit the scope of protection of the present disclosure.

It should be noted that the titles of any sections/subsections provided herein are not restrictive. Various embodiments are described throughout this article, and any type of embodiments may be included under any section/subsection. Furthermore, the embodiments described in any section/subsection may be combined with any other embodiments described in the same section/subsection and/or different sections/subsections in any manner.

In the description of the embodiments of the present disclosure, the term “include/comprise” and similar terms thereof should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. The following may also include other explicit and implicit definitions. The terms “first”, “second”, etc. may refer to different or same objects. The following may also include other explicit and implicit definitions.

The embodiments of the present disclosure may involve user data, data acquisition, and/or data use, etc. All these aspects comply with corresponding laws, regulations, and related provisions. In the embodiments of the present disclosure, all data collection, acquisition, processing, forwarding, and use are performed on the premise that the user is aware of and confirms the data. Accordingly, when implementing the embodiments of the present disclosure, the user should be informed of the type, range of use, use scenarios, etc., of the data or information that may be involved, and the authorization of the user should be obtained, through appropriate means in accordance with relevant laws and regulations. The specific means of informing and/or authorizing may vary according to the actual situation and application scenarios, and the scope of the present disclosure is not limited in this regard.

The solutions in the specification and embodiments, if involving personal information processing, will be performed on the premise that there is a legal basis (for example, the consent of the personal information subject is obtained, or it is necessary to perform a contract, etc.), and will only be performed within the scope of regulations or agreements. If a user refuses to process personal information other than the necessary information required for the basic functions, it will not affect the user's use of the basic functions.

As briefly described above, with technology iterations, the demand for memory resources in the training process of machine learning models has increased significantly, thus causing the problem of insufficient memory resources. As an example, in the case of using a graphics processing unit (GPU) to train a machine learning model, the memory may be, for example, a graphics memory (abbreviated as video memory). Insufficient memory resources may also be referred to as out of memory (OOM).

Taking a generative machine learning model for generating a video as an example, in the training process, a user provides input content and a reference video as sample input, and the generative machine learning model gradually generates a new video similar to the reference video by learning an association relationship between the input content and the reference video.

The training process includes a forward stage and a backward stage. The forward stage may refer to a stage in which sample input is gradually calculated by a plurality of operators in the generative machine learning model to finally generate a predicted output (for example, a new video). The backward stage may refer to a stage in which a gradient is calculated by, for example, backpropagation, and parameters of the generative machine learning model are updated. The operators may refer to basic operation units in the generative machine learning model. The operators may perform specific operation operations (such as addition, convolution, or an activation function) based on input, and use outputs as input of subsequent operators. The output of the operators may also be referred to as output tensors, and the output tensors may include, for example, intermediate activation tensors.

In the forward stage, the output tensors of the operators are stored in a memory (for example, a graphics memory) to be used to calculate gradients in a subsequent backward stage. To facilitate processing of the generative machine learning model, the reference video needs to be processed into a video feature sequence through encoding operations and the like. To fully represent information of the reference video, the length of the video feature sequence is usually long. This results in a large number of output tensors generated in the training process, which requires more memory resources and thus leads to the problem of insufficient memory resources.

In a solution, a memory optimization strategy may be used to reduce the consumption of memory resources in the training process. For example, the memory optimization strategy may instruct to perform memory optimization operations on some operators. The memory optimization operations include, but are not limited to, recomputation operations or offloading operations. The essence of the recomputation operation is to “trade computing resources for memory resources”. Specifically, in the recomputation operation, output tensors generated by some operators in the forward stage are selectively stored, and in the backward stage, operation operations of another part of the operators are re-executed to obtain output tensors that are not stored. In this way, the number of output tensors that need to be stored may be reduced at the cost of certain computing resources, thereby saving the consumption of memory resources. The essence of the parameter offloading operation is to “trade communication resources for memory resources”. Specifically, in the parameter offloading operation, output tensors generated by some operators in the forward stage are transferred to other devices (for example, a memory of a central processing unit). In the backward stage, an output tensor is loaded from another device only when the output tensor is to be used. In this way, the number of output tensors that need to be stored in the memory (for example, the graphics memory of the GPU) may be reduced at the cost of certain communication resources, thereby saving the consumption of memory resources.

In different training periods of a generative machine learning model, sizes of features to be processed may be different. Taking a video generation model as an example, lengths of video feature sequences are often different. For example, in early training of the video generation model, the length of the video feature sequence is generally short, while in intermediate training or late training of the video generation model, the length of the video feature sequence is generally long. This results in different output tensors generated in different training periods, which in turn leads to different consumption degrees of memory resources in different training periods. However, the current memory optimization strategies generally perform memory optimization operations on fixed operators, which will lead to excessive optimization of memory resources in some training periods (such as early training), thus increasing unnecessary occupation of computing/communication resources.

In view of this, embodiments of the present disclosure provide a solution for model training optimization. According to the solution, first, resource usage information related to at least one memory optimization operation is determined for a plurality of operators of a generative machine learning model, where for a memory optimization operation of the at least one memory optimization operation, the resource usage information indicates a resource usage efficiency of performing the memory optimization operation on an operator of the plurality of operators in a training process of the generative machine learning model. Then, a memory optimization strategy for a group of target operators of the plurality of operators is determined based on the resource usage information and available memory resources of a processing device for training the generative machine learning model, the memory optimization strategy indicating performing one of the at least one memory optimization operation on a target operator of the group of target operators. Then, the generative machine learning model is trained by the processing device by applying the memory optimization strategy.

According to the solution of the present disclosure, the resource usage efficiency of performing each memory optimization operation on each operator may be determined based on the resource usage information. The resource usage efficiency may reflect the “cost performance” of performing the memory optimization operation on the operator, for example, whether more memory resources may be saved by paying the same computing/communication resources. On this basis, in combination with the resource usage information and the available memory resources of the processing device, the solution of the present disclosure may preferentially determine operators with high “cost performance” as a group of target operators to be performed memory optimization operations, thereby generating a memory optimization strategy at an operator granularity.

Compared with the traditional memory optimization strategy, the memory optimization strategy in this solution dynamically determines which operators are to be performed the memory optimization operations. In this way, the optimization amount of memory resources may be better matched with the actual available memory resources, thereby avoiding excessive optimization of memory resources and improving model training efficiency. As may be seen from the above description, in the embodiments of the present disclosure, different memory optimization operations may be unified for modeling to more efficiently optimize model training. For example, recomputation and parameter offloading operations may be unified for modeling to achieve comprehensive use and optimization of communication resources and computing resources.

Various example implementations of the solution will be described in more detail below in combination with the drawings.

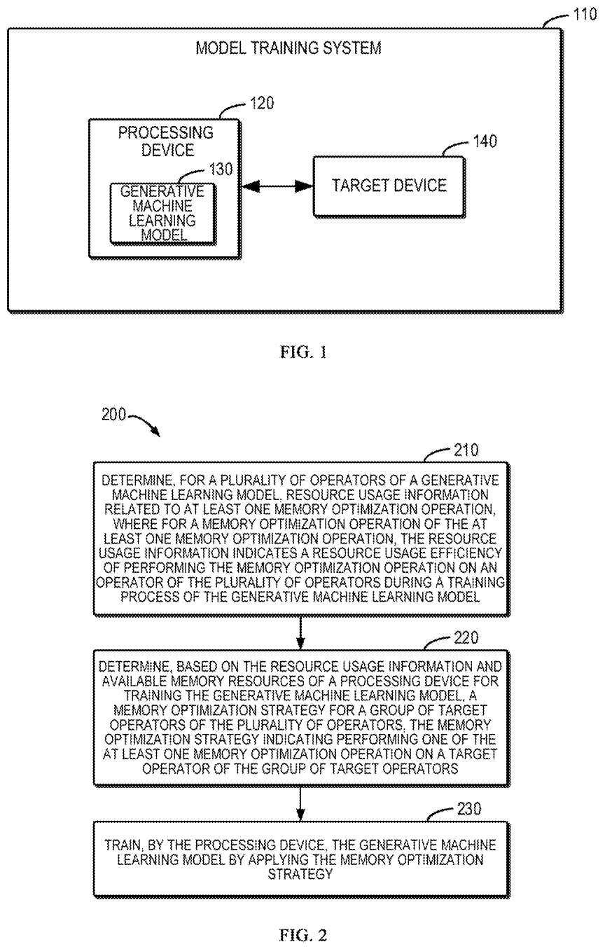

FIG. 1 illustrates a schematic diagram of an example environment 100 according to some embodiments of the present disclosure. Referring to FIG. 1, the example environment 100 may include a model training system 110, a processing device 120, and a generative machine learning model 130.

The model training system 110 may run the generative machine learning model 130 on the processing device 120 to obtain an inference result or train the generative machine learning model 130. The processing device 120 may be any hardware system or hardware platform with computing power. The processing device 120 may be any suitable type of general-purpose processing device or special-purpose processing device. Examples of the general-purpose processing device include, but are not limited to, a central processing unit (CPU), a graphics processing unit (GPU), a field programmable gate array (FPGA), etc. Examples of the special-purpose processing device include, but are not limited to, an accelerated processing unit (APU), a tensor processing unit (TPU), a neural processing unit (NPU), or other existing or future developed artificial intelligence (AI) chips.

In some embodiments, the model training system 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including accessories and peripherals of these devices or any combination thereof. In some embodiments, the model training system 110 may also support any type of user-specific interfaces (such as “wearable” circuits, etc.).

In some embodiments, the model training system 110 may be an independent physical server, a server cluster or distributed system composed of a plurality of physical servers, or a cloud server that provides basic cloud computing services such as cloud services, cloud databases, cloud computing, cloud functions, cloud storage, network services, cloud communications, middleware services, domain name services, security services, content delivery networks, and big data and AI platforms. The model training system 110 may include, for example, a computing system/server, such as a mainframe, an edge computing node, a computing device in a cloud environment, and the like.

It would be appreciated that the structures and functions of various elements in the environment 100 are described for illustrative purposes only, without suggesting any limitation to the scope of the present disclosure.

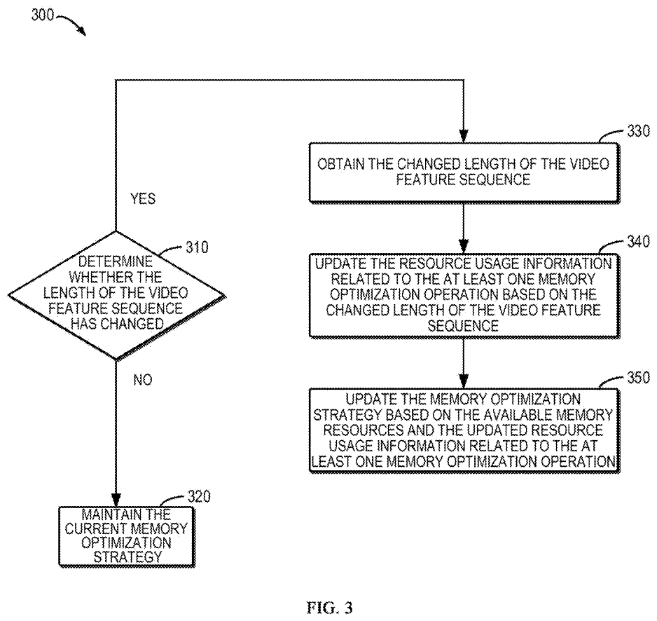

FIG. 2 illustrates a flowchart of an example process 200 of a method for model training optimization according to some embodiments of the present disclosure. The process 200 will be described below in combination with FIG. 1, and the process 200 may be implemented at the model training system 110.

Referring to FIG. 2, at block 210, the model training system 110 determines, for a plurality of operators of the generative machine learning model 130, resource usage information related to at least one memory optimization operation. For any memory optimization operation of the at least one memory optimization operation, the resource usage information indicates a resource usage efficiency that may be achieved by performing the memory optimization operation on any operator of the plurality of operators in the training process of the generative machine learning model 130.

As an example, the generative machine learning model 130 may be a to-be-trained model. In some embodiments, the generative machine learning model 130 may include, but is not limited to, a text generation model, an audio generation model, and/or a video generation model, etc.

As an example, the operators of the generative machine learning model 130 may be basic operation units in the generative machine learning model 130. The operators may perform specific operation operations (such as addition, convolution, or an activation function) based on input, and use outputs as input of subsequent operators. The output of the operators may also be referred to as output tensors, and the output tensors may include, for example, intermediate activation tensors.

In the training process, the generative machine learning model 130 is run on the processing device 120 and consumes memory resources of the processing device 120. As an example, the processing device 120 may include, but is not limited to, a CPU, a GPU, an FPGA, an APU, a TPU, or an NPU, or other existing or future developed AI chips, etc. The memory resources may refer to memory resources configured corresponding to the above-mentioned CPU, GPU, FPGA, APU, TPU, or NPU, or other existing or future developed AI chips. For example, for a GPU, the memory resource may refer to a graphics memory of the GPU, and so on. For the convenience of discussion, unless otherwise specified, the embodiments of the present disclosure will be described below by taking an example in which the processing device 120 is specifically a GPU and the memory resource is the graphics memory of the GPU.

The generative machine learning model 130 is described as an example of a video generation model. Since the input of the video generation model is relatively complex (for example, the video feature sequence in the model input is long due to a large amount of information), each operator of the video generation model will generate a large number of output tensors in the training process. However, these output tensors will consume a large amount of graphics memory of the GPU. To ensure that the training process is smoothly performed, the model training system 110 will generate a memory optimization strategy before the training starts. The memory optimization strategy aims to reduce the consumption of graphics memory by performing at least one memory optimization operation on at least one operator in the training process, thereby avoiding the problem of insufficient graphics memory in the training process.

As an example, the at least one memory optimization operation includes, but is not limited to, a recomputation operation and/or a parameter offloading operation. The essence of the recomputation operation is to “trade computing resources for memory resources”. Specifically, in the recomputation operation, output tensors generated by some operators in the forward stage are selectively stored, and in the backward stage, operation operations of another part of the operators are re-executed to obtain output tensors that are not stored. In this way, the number of output tensors that need to be stored may be reduced at the cost of certain computing resources, thereby saving the consumption of graphics memory. The essence of the parameter offloading operation is to “trade communication resources for memory resources”. Specifically, in the parameter offloading operation, output tensors generated by some operators in the forward stage are transferred to the target device 140 (for example, a memory of a CPU). In the backward stage, an output tensor is loaded from the target device 140 only when the output tensor is to be used. In this way, the number of output tensors that need to be stored in the graphics memory of the GPU may be reduced at the cost of certain communication resources, thereby saving the consumption of graphics memory.

It should be noted that the above is only an example description of the memory optimization operation, which does not constitute a limitation to the embodiments of the present disclosure. For example, according to actual needs, the at least one memory optimization operation may also include other operations other than the recomputation operation and the parameter offloading operation, which will not be listed one by one in the embodiments of the present disclosure.

As an example, each memory optimization operation corresponds to resource usage information. For each memory optimization operation, the resource usage information may indicate the resource usage efficiency that may be achieved by performing the memory optimization operation on each operator in the generative machine learning model 130. As an example, the resource usage efficiency may reflect the “cost performance” of performing the memory optimization operation on the operator, for example, whether more graphics memory may be saved by paying the same computing/communication resources. As an example, for each memory optimization operation, the resource usage efficiency of each operator in the memory optimization operation may be pre-configured or calculated by the model training system 110 in real time, which may be determined specifically according to actual needs. Moreover, for different memory optimization operations, the computation manners of resource usage efficiency may also be different.

In some embodiments, the at least one memory optimization operation includes a recomputation operation, and for each of the plurality of operators, a resource usage efficiency of performing the recomputation operation on the operator in the training process is determined by the following: first, the model training system 110 determines a computation time consumption of performing the recomputation operation on the operator in the training process and a memory resource consumption of the operator on the processing device 120 in the training process. Then, the model training system 110 determines the resource usage efficiency of performing the recomputation operation on the operator in the training process based on a relative relationship between the computation time consumption and the memory resource consumption.

As an example, the computation time consumption of performing the recomputation operation on the operator may refer to the time to be spent when the output tensor of the operator needs to be recalculated. The computation time consumption may be used to quantify the cost of performing the recomputation operation on the operator. According to actual needs, other parameters besides the computation time consumption may also be used to quantify this “cost”, which will not be listed one by one in the embodiments of the present disclosure.

As an example, the memory resource consumption of the operator on the processing device 120 may refer to the memory resources to be occupied by the output tensor of the operator when the output tensor needs to be stored in the memory of the processing device 120. For example, assuming that the processing device 120 is a GPU, the memory resource consumption may refer to the graphics memory to be occupied by the output tensor of the operator.

In some embodiments, for each of the plurality of operators, the memory resource consumption is determined based on model parameters of the generative machine learning model 130 that are related to the operator.

As an example, the model parameters related to the operator include, but is not limited to, a parameter size, a batch size, a sequence length, a hidden size, and/or number heads of attention, etc.

As an example, for an attention block operator in the video generation model, the model training system 110 may calculate its memory resource consumption AB through formula (1):

AB=a*SBH+b*ASB; (1)

where a and b are preset coefficients, S represents a sequence length, B represents a batch size, H represents a hidden size, and A represents a number of attention heads. As an example, a and b may be equal or unequal, for example, a may be 11 or other values, and b may be 4 or other values.

As an example, for a multilayer perceptron block operator in the video generation model, the model training system 110 may calculate its memory resource consumption MLP through formula (2):

MLP=c*SBH; (2)

where c is a preset coefficient, and c may be 18 or other values.

As an example, for other operators in the video generation model, the model training system 110 may calculate their memory resource consumption Ot through formula (3):

Ot=d*SBH; (3)

where d is a preset coefficient, and d may be 12 or other values.

In some embodiments, when calculating the memory resource consumption of the operator, the memory resource consumption may also be adjusted based on tensor parallelism. As an example, the adjustment of the memory resource consumption AB based on the tensor parallelism degree TP may be expressed by formula (4):

AB′=(a*SBH+b*ASB)/TP; (4)

where AB′ represents the memory resource consumption AB adjusted by the tensor parallelism degree TP. By analogy, the embodiments of the present disclosure will not be listed one by one here.

It should be noted that the above description of the model parameter is only an example. Depending on the structure of the generative machine learning model 130, other model parameters other than the above model parameter may also be selected, which may be determined specifically according to actual needs. The embodiments of the present disclosure are not limited thereto.

In this way, the embodiments of the present disclosure may quickly and accurately evaluate the memory resource consumption of each operator in combination with the actual configuration of the generative machine learning model 130.

Once the computation time consumption of performing the recomputation operation on the operator and the memory resource consumption of the operator are determined, the model training system 110 may determine the resource usage efficiency of performing the recomputation operation on the operator based on the relative relationship between the computation time consumption and the memory resource consumption.

As an example, the resource usage efficiency of performing the recomputation operation on the operator aims to reflect the “cost performance” of performing the recomputation operation on the operator. Under this objective, the model training system 110 may calculate the resource usage efficiency of performing the recomputation operation on the operator in any appropriate way. For example, the model training system 110 may determine the resource usage efficiency of performing the recomputation operation on the operator by determining a ratio between the computation time consumption and the memory resource consumption, constructing a mathematical model between the computation time consumption and the memory resource consumption, or other manners.

In this way, the embodiments of the present disclosure may effectively quantify the “cost performance” of performing the recomputation operation on the operator, which facilitates the subsequent process to preferentially select the operator with a higher “cost performance” to perform the recomputation operation.

As an example, for any operator in the video generation model, the model training system 110 may calculate the resource usage efficiency ROI of performing the recomputation operation on the operator through formula (5):

ROI=CT/MS; (5)

where CT represents the computation time consumption of performing the recomputation operation on the operator, and MS represents the memory resource consumption of the operator. MS may also be understood as the memory resources that may be saved when the recomputation operation is performed on the operator.

In some embodiments, the at least one memory optimization operation includes a parameter offloading operation, and the parameter offloading operation is associated with a target device 140 for data transfer. A resource usage efficiency of performing the parameter offloading operation on each of the plurality of operators in the training process is represented by a reference resource usage efficiency. The reference resource usage efficiency is determined by the following: first, the model training system 110 determines a communication time consumption between the processing device 120 and the target device 140 and a reference memory resource consumption associated with the plurality of operators. Then, the model training system 110 determines the reference resource usage efficiency based on a relative relationship between the communication time consumption and the reference memory resource consumption.

As an example, assuming that the processing device 120 is a GPU, the target device 140 may be a CPU. A communication connection may be established between the processing device 120 and the target device 140. The communication connection may be established in a wired or wireless manner. The communication connection may include, but is not limited to, a Bluetooth connection, a mobile network connection, a universal serial bus connection, a wireless fidelity connection, etc. The embodiments of the present disclosure are not limited in this regard. The communication time consumption between the processing device 120 and the target device 140 may refer to the total time required from when data is sent by the processing device 120 to when the data is successfully received and confirmed by the target device 140 in the data transmission process. As an example, the communication time consumption may be determined based on a communication bandwidth between the processing device 120 and the target device 140. For example, the GPU and the CPU are communicatively connected through a peripheral component interconnect express (PCIe), and the communication time consumption between the GPU and the CPU may be determined by the PCIe bandwidth.

As an example, the reference memory resource consumption associated with the plurality of operators may be given in advance or calculated in real time. In some embodiments, the reference memory resource consumption is determined based on an output tensor of at least one of the plurality of operators.

As an example, the output tensor of the operator may be an intermediate activation tensor or the like. The model training system 110 may determine the reference memory resource consumption by calculating sizes of the output tensors of the plurality of operators. For example, the model training system 110 may determine the reference memory resource consumption by calculating an average size, a median size, a maximum size, or other sizes of the output tensors of the plurality of operators.

In this way, the embodiments of the present disclosure may quickly and accurately evaluate the reference memory resource consumption in combination with the actual situations of the output tensors of the plurality of operators.

Once the communication time consumption between the processing device 120 and the target device 140 and the reference memory resource consumption associated with the plurality of operators are determined, the model training system 110 may determine the reference resource usage efficiency based on the relative relationship between the communication time consumption and the reference memory resource consumption.

As an example, the reference resource usage efficiency aims to reflect the “cost performance” of performing the parameter offloading operation on the operator. Under this objective, the model training system 110 may calculate the reference resource usage efficiency in any appropriate way. For example, the model training system 110 may determine the reference resource usage efficiency by determining a ratio between the communication time consumption and the reference memory resource consumption, constructing a mathematical model between the communication time consumption and the reference memory resource consumption, or other manners.

After determining the reference resource usage efficiency, the model training system 110 uses the reference resource usage efficiency to represent the resource usage efficiency of performing the parameter offloading operation on all operators in the generative machine learning model 130. That is, the resource usage efficiency of performing the parameter offloading operation on all operators may be the same.

In this way, the embodiments of the present disclosure may effectively quantify the “cost performance” of performing the parameter offloading operation on the operator in combination with the actual communication between the processing device 120 and the target device 140, so that the recomputation operation with a relatively low “cost performance” may be replaced by performing the parameter offloading operation.

As an example, for the video generation model, the model training system 110 may calculate the reference resource usage efficiency ROI′ through formula (6):

ROI′=TS/PB; (6)

where TS represents the communication time consumption between the GPU and the CPU, and PB represents the reference memory resource consumption.

For each memory optimization operation, after determining the resource usage efficiency of each operator in the memory optimization operation, the resource usage information of the memory optimization operation may be obtained. Next, after obtaining the resource usage information of each memory optimization operation, at block 220, the model training system 110 determines a memory optimization strategy for a group of target operators of the plurality of operators based on the resource usage information and available memory resources of the processing device 120 for training the generative machine learning model 130. The memory optimization strategy indicates performing, on any target operator of the group of target operators, one of the at least one memory optimization operation.

As an example, the available memory resources of the processing device 120 may refer to a remaining amount of the memory resources. For example, assuming that the processing device 120 is a GPU, the available memory resources may refer to the current available graphics memory of the GPU. As an example, for each memory optimization operation, the model training system 110 may determine whether to determine the operator as a target operator based on the resource usage efficiency of each operator.

In some embodiments, the group of target operators includes at least one first target operator on which first memory optimization operation of the at least one memory optimization operation that consumes computing resources is to be performed, and the at least one first target operator is determined by the following: first, the model training system 110 sorts the plurality of operators based on a resource usage efficiency of performing the first memory optimization operation on the operator of the plurality of operators, to obtain an operator sequence. Then, the model training system 110 determines e operators in the operator sequence in sequence as a first target operator of the at least one first target operator until a predetermined condition is met.

As an example, the first memory optimization operation may be, for example, a recomputation operation. It should be noted that, according to actual needs, the first memory optimization operation may also be other operations other than the recomputation operation, such as a gradient accumulation operation, which may be determined specifically according to actual needs, and will not be listed one by one in the embodiments of the present disclosure.

It is assumed that the plurality of operators include an operator A1, an operator A2, an operator A3, an operator A4, and an operator A5. A resource usage efficiency of performing the recomputation operation on the operator A1 is B1, a resource usage efficiency of performing the recomputation operation on the operator A2 is B2, a resource usage efficiency of performing the recomputation operation on the operator A3 is B3, a resource usage efficiency of performing the recomputation operation on the operator A4 is B4, and a resource usage efficiency of performing the recomputation operation on the operator A5 is B5, where B1<B2<B3<B4<B5. The model training system 110 sorts the plurality of operators based on the resource usage efficiency of performing the recomputation operation on the operator of the plurality of operators, and may obtain an operator sequence Q={A5, A4, A3, A2, A1}. The model training system 110 first determines the operator A5 as the first target operator, and then determines whether the predetermined condition is met. If the predetermined condition is met, the process of determining the first target operator ends; otherwise, the operator A4 is determined as the first target operator, and whether the predetermined condition is met is determined. If the predetermined condition is met, the process of determining the first target operator ends; otherwise, the operator A3 is determined as the first target operator, and so on, until the predetermined condition is met.

In this way, the embodiments of the present disclosure may preferentially select the operator with a high “cost performance” for performing the first memory optimization operation, so as to better optimize memory resources at a lower cost (for example, recomputation cost).

In some embodiments, the predetermined condition may include: a memory resource requirement of remaining operators in the operator sequence that are not determined as the at least one first target operator matching the available memory resources. Alternatively or additionally, in some embodiments, the predetermined condition may further include: a resource usage efficiency of performing the first memory optimization operation on the remaining operators being lower than a resource usage efficiency of performing a second memory optimization operation of the at least one memory optimization operation that consumes communication resources.

As an example, that the memory resource requirement of the remaining operators matches the available memory resources may refer to that the available memory resources are greater than or equal to the memory resource requirement of the remaining operators. It is assumed that the model training system 110 sorts the plurality of operators and may obtain the operator sequence Q={A5, A4, A3, A2, A1}. The model training system 110 first determines the operator A5 as the first target operator, and then determines whether a memory resource requirement (for example, graphics memory) of the remaining operators A4, A3, A2, and A1 is less than or equal to the available memory resources (for example, available graphics memory). If the memory resource requirement of the remaining operators A4, A3, A2, and A1 is less than or equal to the available memory resources, the process of determining the first target operator ends; otherwise, the operator A4 is determined as the first target operator, and whether a memory resource requirement of the remaining operators A3, A2, and A1 is less than or equal to the available memory resources is determined. If the memory resource requirement of the remaining operators A3, A2, and A1 is less than or equal to the available memory resources, the process of determining the first target operator ends; otherwise, the operator A3 is determined as the first target operator. By analogy, the process continues until the memory resource requirement of the remaining operators is less than or equal to the available memory resources.

As an example, the second memory optimization operation may be, for example, a parameter offloading operation. It should be noted that, according to actual needs, the second memory optimization operation may also be other operations other than the parameter offloading operation, such as a model parallel operation, which may be determined specifically according to actual needs, and will not be listed one by one in the embodiments of the present disclosure.

As an example, it is assumed that the model training system 110 sorts the plurality of operators and may obtain the operator sequence Q={A5, A4, A3, A2, A1}. The model training system 110 first determines the operator A5 as the first target operator, and then determines whether the resource usage efficiency of performing the second memory optimization operation on the remaining operators A4, A3, A2, and A1 is higher than the resource usage efficiency of performing the first memory optimization operation on these operators. If the resource usage efficiency of performing the second memory optimization operation on the remaining operators A4, A3, A2, and A1 is higher than the resource usage efficiency of performing the first memory optimization operation on these operators, the process of determining the first target operator ends; otherwise, the operator A4 is determined as the first target operator, and whether the resource usage efficiency of performing the second memory optimization operation on the remaining operators A3, A2, and A1 is higher than the resource usage efficiency of performing the first memory optimization operation on these operators is determined. If the resource usage efficiency of performing the second memory optimization operation on the remaining operators A3, A2, and A1 is higher than the resource usage efficiency of performing the first memory optimization operation on these operators, the process of determining the first target operator ends; otherwise, the operator A3 is determined as the first target operator. By analogy, the process continues until the resource usage efficiency of performing the second memory optimization operation on the remaining operators is higher than the resource usage efficiency of performing the first memory optimization operation on these operators.

It should be noted that the above two predetermined conditions may be used individually or in combination, which may be determined specifically according to actual needs, and is not limited in the embodiments of the present disclosure.

In this way, the embodiments of the present disclosure may determine the target operator to be performed the memory optimization operation at an operator granularity. On the one hand, by traversing the operators, the memory resource requirement of the operators may be precisely matched with the available memory resources. On the other hand, the embodiments of the present disclosure may also combine a variety of memory optimization operations to jointly optimize the memory resource consumption, thereby improving optimization efficiency and adapting to different optimization requirements.

In some embodiments, the group of target operators further includes at least one second target operator on which a second memory optimization operation of the at least one memory optimization operation that consumes communication resources is to be performed. The at least one second target operator is determined by the following: first, the model training system 110 determines an operator subset from the operator sequence, where a resource usage efficiency of performing the first memory optimization operation on an operator in the operator subset is lower than a resource usage efficiency of performing the second memory optimization operation. Then, the model training system 110 selects the at least one second target operator from the operator subset based on the available memory resources and memory resources saved by performing the first memory optimization operation on the at least one first target operator.

As an example, it is assumed that the model training system 110 sorts the plurality of operators and may obtain the operator sequence Q={A5, A4, A3, A2, A1}. The model training system 110 determines the operators A5 and A4 as the first target operators. The resource usage efficiency of performing the second memory optimization operation on the remaining operators A3, A2, and A1 is higher than the resource usage efficiency of performing the first memory optimization operation on these operators. Therefore, the model training system 110 determines the remaining operators A3, A2, and A1 as the operator subset.

In some embodiments, the model training system 110 may determine the operators in the operator subset in sequence as the second target operator until a sum of the memory resources saved by performing the first memory optimization operation on the at least one first target operator, memory resources saved by performing the second memory optimization operation on the at least one second target operator, and the available memory resources is greater than or equal to a total memory resource consumption of all the operators.

In some embodiments, the model training system 110 may also determine the operators in the operator subset in sequence as the second target operator until a memory resource requirement of remaining operators in the operator subset that are not determined as the second target operator matches the available memory resources.

As an example, the model training system 110 first determines the operator A3 in the operator subset as the second target operator, and then determines whether a memory resource requirement (for example, graphics memory) of the remaining operators A2 and A1 is less than or equal to the available memory resources (for example, available graphics memory). If the memory resource requirement of the remaining operators A2 and A1 is less than or equal to the available memory resources, the process of determining the second target operator ends; otherwise, the operator A2 is determined as the second target operator, and whether a memory resource requirement of the remaining operator A1 is less than or equal to the available memory resources is determined. By analogy, the process continues until the memory resource requirement of the remaining operators is less than or equal to the available memory resources.

In this way, the embodiments of the present disclosure may quickly and accurately determine which memory optimization operations are performed on which operators to have a better optimization effect, thereby maximizing the efficiency of memory resource optimization.

Once the memory optimization strategy is determined, at block 230, the model training system 110 trains the generative machine learning model 130 using the processing device 120 by applying the memory optimization strategy.

As an example, assuming that the group of target operators include the first target operator and the second target operator described above, in the training process of the generative machine learning model 130, the model training system 110 performs the first memory optimization operation (for example, the recomputation operation) on the first target operator, and performs the second memory optimization operation (for example, the parameter offloading operation) on the second target operator, thereby saving the consumption of memory resources (for example, graphics memory) and avoiding the problem of insufficient memory resources.

In some embodiments, the model training system 110 may monitor whether the input of the generative machine learning model 130 changes before each training process starts. Therefore, the resource usage information and the memory optimization strategy involved in the training process may be dynamically adjusted according to the input change.

In some embodiments, in response to a change in an input tensor of the generative machine learning model 130, the model training system 110 updates the resource usage information related to the at least one memory optimization operation based on the changed input tensor. The change in the tensor includes at least a size change of the input tensor. Then, the model training system 110 updates the memory optimization strategy based on the available memory resources and the updated resource usage information related to the at least one memory optimization operation.

As an example, for the video generation model, the input tensor here may refer to the video feature sequence, and the size change of the input tensor may refer to a change in the length of the video feature sequence. It should be noted that, depending on the type of the generative machine learning model 130, the input tensor here may also be in other forms. The size change is not limited to the length change, and for example, it may also be a dimension change.

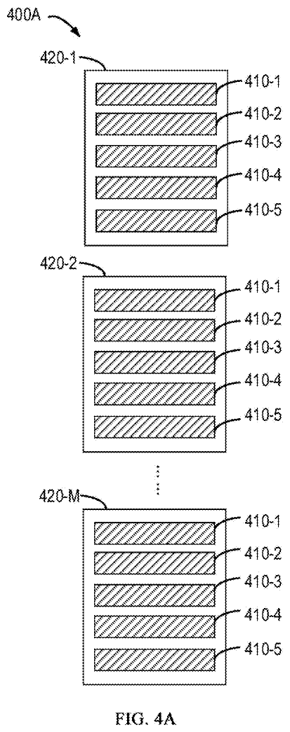

FIG. 3 shows a flowchart of an example process 300 of updating a memory optimization strategy according to some embodiments of the present disclosure. The process 200 will be further described below in conjunction with the process 300. The process 300 is described by taking an example in which the generative machine learning model 130 is a video generation model, but it would be appreciated that the embodiments described with reference to the process 300 are also applicable to other types of models.

At block 310, the model training system 110 determines whether the length of the video feature sequence has changed. If the length of the video feature sequence has not changed, at block 320, the model training system 110 maintains the current memory optimization strategy. If the length of the video feature sequence has changed, at block 330, the model training system 110 obtains the changed length of the video feature sequence.

Next, at block 340, the model training system 110 updates the resource usage information related to the at least one memory optimization operation based on the changed length of the video feature sequence. As an example, for each memory optimization operation, the model training system 110 may re-determine the resource usage efficiency of each operator in the memory optimization operation according to the relevant description of block 210, thereby updating the resource usage information of the memory optimization operation.

Then, at block 350, the model training system 110 updates the memory optimization strategy based on the available memory resources and the updated resource usage information related to the at least one memory optimization operation. As an example, the model training system 110 may re-determine a group of target operators that need to perform the memory optimization operation and which memory optimization operation is to be performed on each target operator according to the relevant description of block 220, thereby updating the memory optimization strategy.

Data amount to be processed in different training processes of the generative machine learning model 130 may be different. For example, in an early training process of the video generation model, the length of the video feature sequence is short, while in a middle and late training process of the video generation model, the length of the video feature sequence is long. In this way, the embodiments of the present disclosure may formulate different memory optimization strategies according to different training processes of the generative machine learning model 130, thereby avoiding excessive optimization of memory resources and improving optimization efficiency.

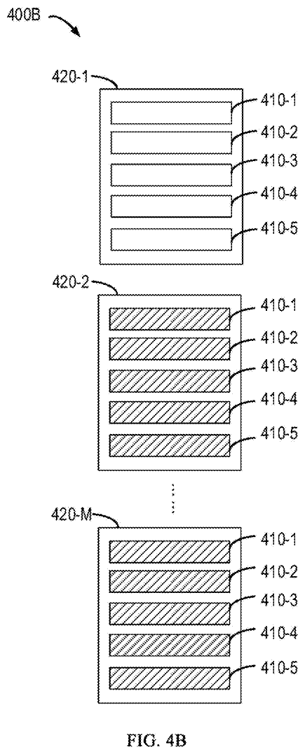

FIG. 4A and FIG. 4B show schematic diagrams of an example 400A and an example 400B of performing memory optimization operations on operators in a traditional solution, and FIG. 4C shows a schematic diagram of an example 400C of performing memory optimization operations on operators according to some embodiments of the present disclosure. The advantages of the embodiments of the present disclosure in optimizing memory resources will be further described below in conjunction with FIG. 4A to FIG. 4C.

Referring to FIG. 4A, in the example 400A, a redundant optimization manner is used to optimize memory resources. That is, regardless of whether the memory resources may meet the requirements of the training process, a memory optimization strategy 400A performs memory optimization operations (such as recomputation operations) on operators 410-1, 410-2, 410-3, 410-4, and 410-5 for each network structure block (such as a transformer block) 420-1, 420-2, . . . , 420-M. The example 400A may ensure that the memory resources meet the requirements of the training process, but it greatly increases the execution cost of the memory optimization operations (for example, a long time-consuming recomputation operation). This leads to a significant decline in training efficiency, and only a small number of training tasks of the generative machine learning model 130 may be completed per unit time.

Referring to FIG. 4B, in the example 400B, whether to optimize the memory resources is determined according to the actual consumption of the memory resources in the current training process. For example, no memory optimization operation is performed on the first network structure block 420-1, and memory optimization operations (such as recomputation operations) are performed on all operators 310-1, 310-2, 310-3, 310-4, and 310-5 in the second network structure block 420-2 and the third network structure block 420-3. The example 400B may improve the excessive optimization of the memory resources to a certain extent, but it regards all the operators 310-1, 310-2, 310-3, 310-4, and 310-5 in the second network structure block 420-2 and the third network structure block 420-3 as a whole to uniformly decide whether to perform the memory optimization operation, so there is still a large amount of resource waste.

Referring to FIG. 4C, in the embodiments of the present disclosure, an operator granularity memory optimization strategy is formulated according to the actual consumption of the memory resources in the current training process in combination with the resource usage efficiency of each operator in each memory optimization operation.

For example, the operators 310-3 and 310-4 in the first network structure block 420-1 have a high resource usage efficiency in the recomputation operation, which is higher than the resource usage efficiency of these operators in the parameter offloading operation. Therefore, the operators 310-3 and 310-4 in the first network structure block 420-1 may be determined as the first target operators on which the recomputation operation is to be performed. The operator 310-5 in the first network structure block 420-1 has a higher resource usage efficiency in the parameter offloading operation than the resource usage efficiency in the recomputation operation. Therefore, the operator 310-5 in the first network structure block 420-1 may be determined as the second target operator on which the parameter offloading operation is to be performed.

The operators 310-3 to 310-5 in the second network structure block 420-2 have a high resource usage efficiency in the recomputation operation, which is higher than the resource usage efficiency of these operators in the parameter offloading operation. Therefore, the operators 310-3 to 310-5 in the second network structure block 420-2 may be determined as the first target operators on which the recomputation operation is to be performed.

The operators 310-3 and 310-4 in the third network structure block 420-M have a high resource usage efficiency in the recomputation operation, which is higher than the resource usage efficiency of these operators in the parameter offloading operation. Therefore, the operators 310-3 and 310-4 in the third network structure block 420-M may be determined as the first target operators on which the recomputation operation is to be performed. The operator 310-2 in the third network structure block 420-M has a higher resource usage efficiency in the parameter offloading operation than the resource usage efficiency in the recomputation operation. Therefore, the operator 310-2 in the third network structure block 420-M may be determined as the second target operator on which the parameter offloading operation is to be performed.

In this way, the embodiments of the present disclosure may formulate the operator granularity memory optimization strategy, and the memory optimization strategy considers the resource usage efficiency of the operator in a variety of memory optimization operations to select the best memory optimization operation for the operator. Therefore, the embodiments of the present disclosure may ensure that an optimization amount of the memory resources is strictly matched with a requirement amount of the memory resources, thereby avoiding waste of the memory resources and greatly improving the throughput of model training.

It should be noted that although the embodiments of the present disclosure are described by taking the generative machine learning model 130 as an example, this does not constitute a limitation to the embodiments of the present disclosure. Alternatively, in some embodiments, the model training system 110 may also optimize memory resources of other machine learning models other than the generative machine learning model 130 according to the processes shown in blocks 210 to 230. For example, the other machine learning models other than the generative machine learning model 130 may include discriminative machine learning models.

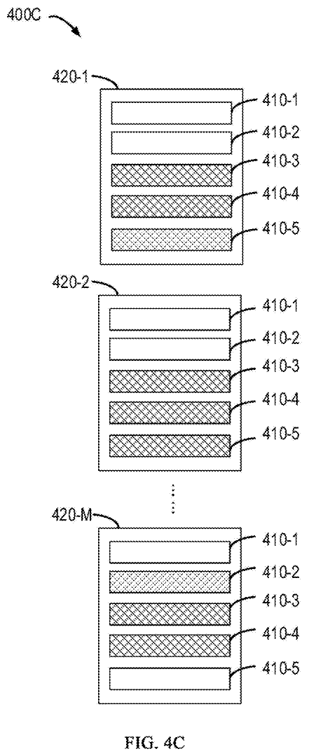

The embodiments of the present disclosure also provide corresponding apparatuses for implementing the above methods or processes. FIG. 5 shows a schematic structural block diagram of an apparatus 500 for model training optimization according to some embodiments of the present disclosure. The apparatus 500 may be implemented as or included in the model training system 110. Each module/component in the apparatus 500 may be implemented by hardware, software, firmware, or any combination thereof.

Referring to FIG. 5, the apparatus 500 includes a resource usage information determination module 510, a memory optimization strategy determination module 520, and a model training module 530. The resource usage information determination module 510 is configured to determine, for a plurality of operators of a generative machine learning model, resource usage information related to at least one memory optimization operation, where for a memory optimization operation of the at least one memory optimization operation, the resource usage information indicates a resource usage efficiency of performing the memory optimization operation on an operator of the plurality of operators in a training process of the generative machine learning model. The memory optimization strategy determination module 520 is configured to determine, based on the resource usage information and available memory resources of a processing device for training the generative machine learning model, a memory optimization strategy for a group of target operators of the plurality of operators, the memory optimization strategy indicating performing one of the at least one memory optimization operation on a target operator of the group of target operators. The model training module 530 is configured to train, by the processing device, the generative machine learning model by applying the memory optimization strategy.

In some embodiments, the group of target operators include at least one first target operator on which a first memory optimization operation of the at least one memory optimization operation that consumes computing resources is to be performed, and the memory optimization strategy determination module 520 is further configured to: sort the plurality of operators based on a resource usage efficiency of performing the first memory optimization operation on an operator of the plurality of operators, to obtain an operator sequence; and determine operators in the operator sequence in sequence as a first target operator of the at least one first target operator until a predetermined condition is met.

In some embodiments, the predetermined condition includes at least one of: a memory resource requirement of remaining operators in the operator sequence that are not determined as the at least one first target operator matches the available memory resources, or a resource usage efficiency of performing the first memory optimization operation on the remaining operators is lower than a resource usage efficiency of performing a second memory optimization operation of the at least one memory optimization operation that consumes communication resources.

In some embodiments, the group of target operators further include at least one second target operator on which the second memory optimization operation of the at least one memory optimization operation that consumes communication resources is to be performed, and the memory optimization strategy determination module 520 is further configured to: determine an operator subset from the operator sequence, where a resource usage efficiency of performing the first memory optimization operation on an operator in the operator subset is lower than a resource usage efficiency of performing the second memory optimization operation; and select the at least one second target operator from the operator subset based on the available memory resources and memory resources saved by performing the first memory optimization operation on the at least one first target operator.

In some embodiments, the at least one memory optimization operation includes a recomputation operation, and the resource usage information determination module 510 is further configured to: determine a computation time consumption of performing the recomputation operation on the operator in the training process and a memory resource consumption of the operator on the processing device in the training process; and determine a resource usage efficiency of performing the recomputation operation on the operator in the training process based on a relative relationship between the computation time consumption and the memory resource consumption.

In some embodiments, for each operator of the plurality of operators, the memory resource consumption is determined based on model parameters of the generative machine learning model that are related to the operator.

In some embodiments, the at least one memory optimization operation includes a parameter offloading operation, the parameter offloading operation is associated with a target device for data transfer, a resource usage efficiency of performing the parameter offloading operation on each of the plurality of operators in the training process is represented by a reference resource usage efficiency, and the resource usage information determination module 510 is further configured to: determine a communication time consumption between the processing device and the target device and a reference memory resource consumption associated with the plurality of operators; and determine the reference resource usage efficiency based on a relative relationship between the communication time consumption and the reference memory resource consumption.

In some embodiments, the reference memory resource consumption is determined based on an output tensor of at least one operator of the plurality of operators.

In some embodiments, the apparatus 500 further includes an updating module. The updating module is configured to: in response to a change in an input tensor of the generative machine learning model, update the resource usage information related to the at least one memory optimization operation based on the changed input tensor, where the change includes at least a size change of the input tensor; and update the memory optimization strategy based on the available memory resources and the updated resource usage information related to the at least one memory optimization operation.

In some embodiments, the generative machine learning model includes a video generation model.

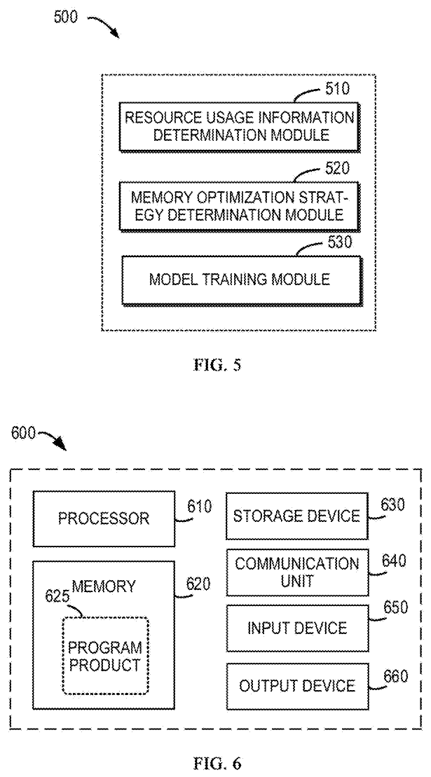

FIG. 6 shows a block diagram of an electronic device 600 in which one or more embodiments of the present disclosure may be implemented. The electronic device 600 may be used, for example, to implement the model training system 110 shown in FIG. 1 or the apparatus 500 shown in FIG. 5. It would be appreciated that the electronic device 600 shown in FIG. 6 is only exemplary, without suggesting any limitation to the functions and scope of the embodiments described herein.

Referring to FIG. 6, the electronic device 600 is in the form of a general-purpose electronic device. Components of the electronic device 600 may include, but are not limited to, one or more processors 610, a memory 620, a storage device 630, one or more communication units 640, one or more input devices 650, and one or more output devices 660. The processor 610 may be an actual or virtual processor and may perform various processing based on programs stored in the memory 620. In a multi-processor system, a plurality of processors perform computer-executable instructions in parallel to improve the parallel processing capability of the electronic device 600.

The electronic device 600 typically includes a plurality of computer storage medium. Such medium may be any available medium accessible to the electronic device 600, including, but not limited to, volatile and non-volatile medium, removable and non-removable medium. The memory 620 may be a volatile memory (for example, a register, a cache, a random access memory (RAM)), a non-volatile memory (such as a read-only memory (ROM), an electrically erasable programmable read-only memory (EEPROM), a flash memory), or any combination thereof. The storage device 630 may be a removable or non-removable medium, and may include a machine-readable medium such as a flash drive, a disk, or any other medium, which may be used to store information and/or data and may be accessed within the electronic device 600.

The electronic device 600 may further include additional removable/non-removable, volatile/non-volatile memory medium. Although not shown in FIG. 5, a disk driver for reading from or writing to a removable, non-volatile disk (such as a “floppy disk”), and an optical disk driver for reading from or writing to a removable, non-volatile optical disk may be provided. In these cases, each driver may be connected to a bus (not shown) by one or more data medium interfaces. The memory 620 may include a computer program product 625, which has one or more program modules configured to perform various methods or actions of various embodiments of the present disclosure.

The communication unit 640 enables communication with other electronic devices via the communication medium. Additionally, the functions of the components of the electronic device 600 may be implemented by a single computing cluster or a plurality of computing machines, which may communicate via communication connections. Therefore, the electronic device 600 may use a logical connection with one or more other servers, network personal computers (PCs) or other network nodes to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) as needed via the communication unit 640, the external devices such as the storage devices, display devices, etc., communicate with one or more devices that enable a user to interact with the electronic device 600, or communicate with any devices (such as a network card, a modem, etc.) that enable the electronic device 600 to communicate with one or more other electronic devices. Such communication may be performed via input/output (I/O) interfaces (not shown).

According to an exemplary implementation of the present disclosure, a computer-readable storage medium is provided, which has computer-executable instructions stored thereon, where the computer-executable instructions are executed by a processor to perform the method described above. According to an exemplary implementation of the present disclosure, there is also provided a computer program product, which is tangibly stored on a non-transitory computer-readable medium and includes computer-executable instructions, and the computer-executable instructions are executed by a processor to perform the method described above.

Aspects of the present disclosure are described herein with reference to flowcharts and/or block diagrams of methods, apparatuses, devices and computer program products implemented according to the present disclosure. It would be appreciated that each block of the flowcharts and/or block diagrams, and combinations of the blocks in the flowcharts and/or block diagrams, may be implemented by computer-readable program instructions.

These computer-readable program instructions may be provided to a processor of a general-purpose computer, a special-purpose computer, or other programmable data processing apparatus to produce a machine, such that these instructions, when executed by the processor of the computer or other programmable data processing apparatus, produce an apparatus for implementing a function/action specified in one or more blocks of the flowcharts and/or block diagrams. These computer-readable program instructions may also be stored in a computer-readable storage medium, these instructions cause a computer, a programmable data processing apparatus and/or other devices to work in a specific way, so that the computer-readable medium storing the instructions includes a manufactured product, which includes instructions for implementing various aspects of the function/action specified in one or more blocks of the flowcharts and/or block diagrams.

The computer-readable program instructions may be loaded onto a computer, other programmable data processing apparatus, or other devices, so that a series of operation steps are performed on the computer, other programmable data processing apparatus, or other devices to produce a computer-implemented process, so that the instructions executed on the computer, other programmable data processing apparatus, or other devices implement the function/action specified in one or more blocks of the flowcharts and/or block diagrams.

The flowcharts and block diagrams in the drawings show the possibly implemented architectures, functions, and operations of the systems, methods and computer program products according to a plurality of implementations of the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts, may be implemented by a special-purpose hardware-based system that perform specified functions or actions, or may be implemented by a combination of special-purpose hardware and computer instructions.

The implementations of the present disclosure have been described above, and the above description is exemplary, non-exhaustive, and not limited to the disclosed implementations. Without departing from the scope and spirit of the illustrated implementations, many modifications and changes will be apparent to those of ordinary skill in the art. The determination of the terms used herein is intended to best explain the principles, practical applications, or improvements of the technology in the market of the implementations, or to enable other ordinary skilled persons in the art to understand the implementations disclosed herein.

1. A method for model training optimization, comprising:
determining, for a plurality of operators of a generative machine learning model, resource usage information related to at least one memory optimization operation, wherein for a memory optimization operation of the at least one memory optimization operation, the resource usage information indicates a resource usage efficiency of performing the memory optimization operation on an operator of the plurality of operators in a training process of the generative machine learning model;
determining, based on the resource usage information and available memory resources of a processing device for training the generative machine learning model, a memory optimization strategy for a group of operators of the plurality of operators, the memory optimization strategy indicating performing one of the at least one memory optimization operation on a target operator of the group of operators; and
training, by the processing device, the generative machine learning model by applying the memory optimization strategy.

2. The method of claim 1, wherein the group of operators comprises at least one first target operator on which a first memory optimization operation of the at least one memory optimization operation that consumes computing resources is to be performed, and the at least one first target operator is determined by:
sorting the plurality of operators based on a resource usage efficiency of performing the first memory optimization operation on an operator of the plurality of operators, to obtain an operator sequence; and
determining operators in the operator sequence in sequence as a first target operator of the at least one first target operator until a predetermined condition is met.

3. The method of claim 2, wherein the predetermined condition comprises at least one of:
a memory resource requirement of remaining operators in the operator sequence that are not determined as the at least one first target operator matches the available memory resources, or
a resource usage efficiency of performing the first memory optimization operation on the remaining operators is lower than a resource usage efficiency of performing a second memory optimization operation of the at least one memory optimization operation that consumes communication resources.

4. The method of claim 2, wherein the group of operators further comprises at least one second target operator on which a second memory optimization operation of the at least one memory optimization operation that consumes communication resources is to be performed, and the at least one second target operator is determined by:
determining an operator subset from the operator sequence, wherein a resource usage efficiency of performing the first memory optimization operation on an operator in the operator subset is lower than a resource usage efficiency of performing the second memory optimization operation; and
selecting the at least one second target operator from the operator subset based on the available memory resources and memory resources saved by performing the first memory optimization operation on the at least one first target operator.

5. The method of claim 1, wherein the at least one memory optimization operation comprises a recomputation operation, and for each operator of the plurality of operators, a resource usage efficiency of performing the recomputation operation on the operator in the training process is determined by:
determining a computation time consumption of performing the recomputation operation on the operator in the training process and a memory resource consumption of the operator on the processing device in the training process; and
determining the resource usage efficiency of performing the recomputation operation on the operator in the training process based on a relative relationship between the computation time consumption and the memory resource consumption.

6. The method of claim 5, wherein for each operator of the plurality of operators, the memory resource consumption is determined based on model parameters of the generative machine learning model that are related to the operator.

7. The method of claim 1, wherein the at least one memory optimization operation comprises a parameter offloading operation, the parameter offloading operation is associated with a device for data transfer, a resource usage efficiency of performing the parameter offloading operation on each of the plurality of operators in the training process is represented by a reference resource usage efficiency, and the reference resource usage efficiency is determined by:
determining a communication time consumption between the processing device and the device for data transfer and a reference memory resource consumption associated with the plurality of operators; and
determining the reference resource usage efficiency based on a relative relationship between the communication time consumption and the reference memory resource consumption.

8. The method of claim 7, wherein the reference memory resource consumption is determined based on an output tensor of at least one operator of the plurality of operators.

9. The method of claim 1, further comprising:
updating, in response to a change in an input tensor of the generative machine learning model, the resource usage information related to the at least one memory optimization operation based on the changed input tensor, wherein the change comprises at least a size change of the input tensor; and
updating the memory optimization strategy based on the available memory resources and the updated resource usage information related to the at least one memory optimization operation.

10. The method of claim 1, wherein the generative machine learning model comprises a video generation model.

11. An electronic device, comprising:
at least one processor; and
at least one memory coupled to the at least one processor and storing instructions executable by the at least one processor, the instructions, when executed by the at least one processor, causing the electronic device to perform operations comprising:
determining, for a plurality of operators of a generative machine learning model, resource usage information related to at least one memory optimization operation, wherein for a memory optimization operation of the at least one memory optimization operation, the resource usage information indicates a resource usage efficiency of performing the memory optimization operation on an operator of the plurality of operators in a training process of the generative machine learning model;
determining, based on the resource usage information and available memory resources of a processing device for training the generative machine learning model, a memory optimization strategy for a group of operators of the plurality of operators, the memory optimization strategy indicating performing one of the at least one memory optimization operation on a target operator of the group of operators; and
training, by the processing device, the generative machine learning model by applying the memory optimization strategy.

12. The electronic device of claim 11, wherein the group of operators comprises at least one first target operator on which a first memory optimization operation of the at least one memory optimization operation that consumes computing resources is to be performed, and the at least one first target operator is determined by:
sorting the plurality of operators based on a resource usage efficiency of performing the first memory optimization operation on an operator of the plurality of operators, to obtain an operator sequence; and
determining operators in the operator sequence in sequence as a first target operator of the at least one first target operator until a predetermined condition is met.

13. The electronic device of claim 12, wherein the predetermined condition comprises at least one of:
a memory resource requirement of remaining operators in the operator sequence that are not determined as the at least one first target operator matches the available memory resources, or
a resource usage efficiency of performing the first memory optimization operation on the remaining operators is lower than a resource usage efficiency of performing a second memory optimization operation of the at least one memory optimization operation that consumes communication resources.

14. The electronic device of claim 12, wherein the group of operators further comprises at least one second target operator on which a second memory optimization operation of the at least one memory optimization operation that consumes communication resources is to be performed, and the at least one second target operator is determined by:
determining an operator subset from the operator sequence, wherein a resource usage efficiency of performing the first memory optimization operation on an operator in the operator subset is lower than a resource usage efficiency of performing the second memory optimization operation; and
selecting the at least one second target operator from the operator subset based on the available memory resources and memory resources saved by performing the first memory optimization operation on the at least one first target operator.

15. The electronic device of claim 11, wherein the at least one memory optimization operation comprises a recomputation operation, and for each operator of the plurality of operators, a resource usage efficiency of performing the recomputation operation on the operator in the training process is determined by:
determining a computation time consumption of performing the recomputation operation on the operator in the training process and a memory resource consumption of the operator on the processing device in the training process; and
determining the resource usage efficiency of performing the recomputation operation on the operator in the training process based on a relative relationship between the computation time consumption and the memory resource consumption.

16. The electronic device of claim 15, wherein for each operator of the plurality of operators, the memory resource consumption is determined based on model parameters of the generative machine learning model that are related to the operator.

17. The electronic device of claim 11, wherein the at least one memory optimization operation comprises a parameter offloading operation, the parameter offloading operation is associated with a device for data transfer, a resource usage efficiency of performing the parameter offloading operation on each of the plurality of operators in the training process is represented by a reference resource usage efficiency, and the reference resource usage efficiency is determined by:
determining a communication time consumption between the processing device and the device for data transfer and a reference memory resource consumption associated with the plurality of operators; and
determining the reference resource usage efficiency based on a relative relationship between the communication time consumption and the reference memory resource consumption.

18. The electronic device of claim 17, wherein the reference memory resource consumption is determined based on an output tensor of at least one operator of the plurality of operators.

19. The electronic device of claim 11, wherein the operations further comprise:
updating, in response to a change in an input tensor of the generative machine learning model, the resource usage information related to the at least one memory optimization operation based on the changed input tensor, wherein the change comprises at least a size change of the input tensor; and
updating the memory optimization strategy based on the available memory resources and the updated resource usage information related to the at least one memory optimization operation.

20. A non-transitory computer-readable storage medium having computer-executable instructions stored thereon, wherein the computer-executable instructions are executable by a processor to perform the method of claim 1.
